(19) United States
(12) Patent Application Publication
(10) Pub. No.: US 2026/0221827 A1
(43) Pub. Date: Jul. 30, 2026

(54) ELECTRICALLY EXCITED SYNCHRONOUS MOTOR DIRECT ROTOR COOLING

(71) Applicant: FCA US LLC, Auburn Hills, MI (US)

(72) Inventors: Dhafar Al-Ani, Auburn Hills, MI (US); Batahan Sirri Yilmaz, Hamilton (CA); Berker Bilgin, Hamilton (CA)

(21) Appl. No.: 19/040,997

(22) Filed: Jan. 30, 2025

(51) Int. Cl. H02K 1/32; H02K 1/24; H02K 9/193

(52) U.S. Cl. CPC H02K 1/32; H02K 1/24; H02K 9/193

(57) ABSTRACT

An electric motor for powering an electric vehicle includes a rotor and coils. The rotor is configured to rotate relative to a stator to drive a rotor shaft and at least one drive wheel of the electric vehicle wherein the rotor shaft defines a passage having an inlet and a plurality of radially formed outlet passages. The rotor comprises: a plurality of first laminations arranged along a central portion of the rotor, and define a plurality of first channels that extend in a radial direction and are configured to receive cooling fluid from the outlet passages; and a plurality of second laminations arranged at opposite ends of the rotor, and define a plurality of second channels that extend in an axial direction and are configured to receive the cooling fluid from the plurality of first channels and expel the cooling fluid onto the coils.

### FIELD

The present application relates generally to electrically excited synchronous motors and more particularly to a configuration having direct cooling of the rotor.

### BACKGROUND

Different types of electric vehicles, including mild hybrid electric vehicles (mHEV's), plug-in hybrid electric vehicles (PHEV's), battery electric vehicles (BEV's), and extended-range battery electric vehicles (EREV's), rely on electric machines or motors for propulsion as a main source of torque, which generates the necessary power for vehicle propulsion. Many electric motors incorporate permanent magnets. Due to sustainability and global supply challenges associated with rare-earth magnets, there is a growing demand for magnet-free electric motors. Once prominent topology of electric motors in the category is an electrically excited synchronous motor (ESSM). These electric motors use coils (known as magnet wires or copper wires) on the rotor poles instead of permanent magnets. However, this design generates extra heat and necessitates an additional rotor cooling method for the electric motor. Some conventional cooling methods for electric motors use a water jacket around the stator and/or housing. While the water jacket configuration is common, it can be less efficient compared to spray coolant (oil). In this regard, while existing ESSM cooling configurations can be satisfactory, there remains a need for improvement in the relevant art.

### SUMMARY

In accordance with one example aspect of the invention, an electric motor for powering an electric vehicle includes a rotor and coils. The rotor is configured to rotate relative to a stator to drive a rotor shaft and at least one drive wheel of the electric vehicle wherein the rotor shaft defines a passage having an inlet and a plurality of radially formed outlet passages. The coils are positioned at respective poles of the rotor. The rotor comprises: a plurality of first laminations arranged along a central portion of the rotor, the plurality of first laminations defining a plurality of first channels that extend in a radial direction and are configured to receive cooling fluid from the outlet passages; and a plurality of second laminations arranged at opposite ends of the rotor, the plurality of second laminations defining a plurality of second channels that extend in an axial direction and are configured to receive the cooling fluid from the plurality of first channels and expel the cooling fluid onto the coils.

In examples, the rotor defines a plurality of rotor inlet passages that receive the cooling fluid from the rotor shaft.

In examples, the plurality of rotor inlet passages align with the plurality of outlet passages on the rotor shaft.

In other implementations, the plurality of first channels have a linear geometry.

In examples, the plurality of second channels have an arcuate geometry.

In other examples, first arcuate distal end portions are defined at ends of the plurality of first channels.

In additional features, the first arcuate distal end portions align with the plurality of second channels.

In other examples, the electric motor further includes a housing that houses the rotor, wherein the housing defines at least one hole that the cooling fluid drains out of after engaging the coils and returns to the rotor shaft by way of a sump mechanism.

In additional features, the cooling fluid comprises oil.

In additional examples, the coils are directly sprayed from the rotor.

In other examples, the coils are directly sprayed from the plurality of second channels.

In additional features, the stator is fixed to the housing.

In additional examples, the electric motor further comprises a plurality of caps attached to the rotor and that guide oil splashing onto the coils.

In other implementations, the plurality of caps are attached to the rotor.

In examples, the plurality of caps are formed of plastic.

A method of cooling coils of an electric motor that powers an electric vehicle is provided. The method includes: providing a rotor configured to rotate relative to a stator to drive a rotor shaft and at least one drive wheel of the electric vehicle, wherein the rotor shaft defines a passage having an inlet and a plurality of radially formed outlet passages, the rotor having a plurality of first laminations arranged along a central portion of the rotor, the plurality of first laminations defining a plurality of first channels that extend in a radial direction and are configured to receive cooling fluid from the outlet passages; and a plurality of second laminations arranged at opposite ends of the rotor, the plurality of second laminations defining a plurality of second channels that extend in an axial direction and are configured to receive the cooling fluid from the plurality of first channels and expel the cooling fluid onto the coils; delivering the cooling fluid through the passage in the rotor shaft; directing the cooling fluid from the outlet passages in the rotor shaft into the plurality of first channels; directing the cooling fluid from the plurality of first channels to the plurality of second channels; and expelling the cooling fluid from the plurality of second channels and onto the coils, whereby the coils are cooled from the cooling fluid.

In additional features, the method includes: subsequent to expelling the cooling fluid, draining the oil through at least one hole in a housing that houses the rotor and into a sump.

In other features, the method includes: pumping the oil from the sump back to the rotor shaft.

In further implementations, delivering the cooling fluid comprises: delivering oil.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings references therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a schematic illustration of an example electric vehicle drivetrain having an electric drive module that incorporates an electrically excited synchronous motor (ESSM) constructed in accordance with the principles of the present application;

FIG. 2A is a sectional view of an ESSM constructed in accordance to one prior art example having a shaft cooling configuration;

FIG. 2B is a sectional view of an ESSM constructed in accordance to another prior art example having a liquid cooled rotor configuration;

FIG. 2C is a sectional view of an ESSM constructed in accordance to one example of the present disclosure;

FIG. 3 is an exploded perspective view of an ESSM having a stator, a rotor, rotor coils and a shaft constructed in accordance to one example of the present disclosure;

FIG. 4 is an exploded perspective view of an ESSM of FIG. 3;

FIG. 5 is a sectional view of the ESSM taken along lines 5-5 of FIG. 3;

FIG. 6A is a plan view of a first rotor lamination of the rotor shown in FIG. 4, the first rotor lamination having axial oil channels formed thereon;

FIG. 6B is a plan view of a second rotor lamination of the rotor shown in FIG. 4, the second lamination having axial and radial oil channels formed thereon;

FIG. 7A is a partial perspective view of the rotor of FIG. 4;

FIG. 7B is a sectional view of the rotor taken along lines 7B-7B of FIG. 4; and

FIG. 8 is a schematic representation of oil flow through the shaft and rotor of the EESM of FIG. 3 according to one example of the present disclosure.

### DETAILED DESCRIPTION

As noted above, electric motors are used in various types of electrified vehicles to generate the necessary power for vehicle propulsion. Once prominent topology of electric motors in the category is an electrically excited synchronous motor (ESSM). These electric motors use coils (known as magnet wires or copper wires) on the rotor poles instead of permanent magnets. However, this design generates extra heat and necessitates an additional rotor cooling method for the electric motor.

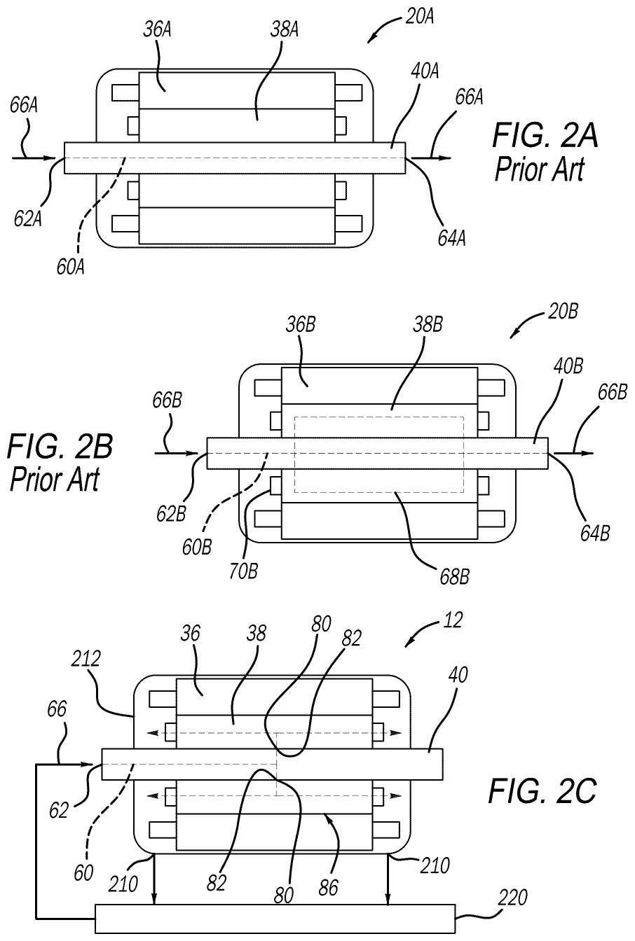

Some conventional cooling methods for electric motors use a water jacket around the stator and/or housing. While the water jacket configuration is common, it can be less efficient compared to spray coolant (oil). Spray cooling from the housing is sufficient for most permanent magnet synchronous motors (PMSMs), as they do not have additional coils on the rotor. For EESMs, the rotor is mainly cooled through its shaft (FIG. 2a). In other configurations, sealed laminations on the rotor are oil-cooled, which creates a loop in the rotor to access more surface area without touching the rotor coils (FIG. 2b).

While there are various types of electric motors that do not use permanent magnets, they often cannot compete with permanent magnet synchronous motors in terms of power density and efficiency without an extra cooling system due to their additional rotor heating. To manage the thermal performance of electrically excited synchronous motors in electric vehicles, the motor sizes are increased to match the power output of permanent magnet synchronous motors. This results in larger stator and rotor volumes, which in turn requires larger enclosures for the electric motors.

The primary goal for electric vehicle components is to keep the parts smaller and lighter to either compensate for the heavy battery weight or create more space for the electric drive system. This ultimately enhances the flexibility of the overall system of electric vehicles. The EESM disclosed herein solves the main heating problem in electrically excited synchronous motors by cooling the rotor coil parts in a way that allows them to compete with permanent magnet synchronous motors in terms of power density and efficiency. This enables electrically excited synchronous motors to handle more current and achieve higher power outputs.

The present disclosure provides a configuration where the rotor coils are sprayed directly (FIG. 2c). The cooling fluid, such as oil, is fed through an inlet of the rotor shaft. Thereafter, the oil exits passages on the rotor shaft and is fed through rotor channels and onto the rotor coils. The oil then drains through holes on the bottom side of the housing. The rotor oil channels can be designed and optimized (using different channel locations, quantities, sizes, shapes and oil flow patterns) to achieve maximum cooling performances without affecting the electromagnetic and mechanical aspects of the EESM.

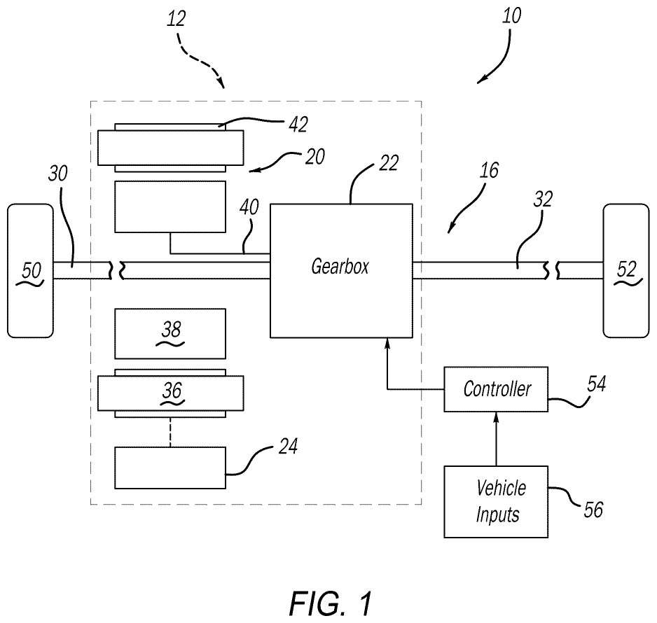

With initial reference to FIG. 1, a vehicle 10 is partially shown in accordance with the principles of the present disclosure. In the example embodiment, vehicle 10 includes an electric drive module (EDM) 12 configured to generate and transfer drive torque to a driveline 16 for vehicle propulsion. The EDM 12 generally includes one or more electric drive units or machines 20 (e.g., electric traction machines), a gearbox assembly 22, and power electronics including a power inverter module (PIM) 24.

As used herein, the electric motor 20 are also referred to as an electric motor. The electric motor 20 is selectively connectable via the PIM 24 to a high voltage battery system (not shown) for powering the electric motor 20. The gearbox assembly 22 is configured to transfer the generated drive torque to the driveline 16, including a first or left axle shaft 30 and a second or right axle shaft 32. In the example shown, the EDM 12 is configured for use on a rear axle of a two-wheel drive vehicle. It is appreciated however that the EDM 12 can be alternatively configured for use on a front axle of a two-wheel drive vehicle. In other examples an EDM 12 can be provided on both of the front and rear axles for a four-wheel drive or all-wheel drive driveline vehicle.

In the example embodiment, the electric motor 20 generally includes a stator 36, a rotor 38, and a rotor output shaft 40. The stator 36 is fixed (e.g., to a housing 42) and the rotor 38 is configured to rotate relative to the stator 36 to drive the rotor shaft 40 and thus the vehicle axles 30, 32 (e.g., half shafts) and therefore respective drive wheels 50, 52. In the illustrated example, the EDM 12 is configured for a rear axle (axles 30, 32) of the vehicle 10, but it will be appreciated that the systems and methods described herein are equally applicable to a front axle EDM configuration, and can be replicated on the front and rear axles for four wheel drive. In examples, the vehicle 10 can include a controller 54 that receives vehicle inputs 56. The controller 54 can communicate signals to the gearbox 22 for operating the EDM 12 according to various driver requested modes and/or alter an operating condition based on sensed vehicle parameters.

With additional reference now to FIG. 2A, a sectional view of an ESSM 20A constructed in accordance to one prior art example is shown. The EESM 20A generally includes a stator 36A, a rotor 38A and a rotor shaft 40A. The EESM 20A has a shaft cooling configuration whereby the rotor shaft 40A defines a passage 60A. The passage 60A includes an inlet 62A and an outlet 64A. Oil 66A flows through the passage 60A from the inlet 62A to the outlet 64A and provides a cooling function to the rotor 38A of the EESM 20A.

With additional reference now to FIG. 2B, a sectional view of an ESSM 20B constructed in accordance to one prior art example is shown. The EESM 20B generally includes a stator 36B, a rotor 38B and a rotor shaft 40B. The EESM 20B has a liquid cooled rotor configuration whereby the rotor shaft 40B defines a passage 60B. The passage 60B includes an inlet 62B and an outlet 64B. Oil 66B flows through the passage 60B from the inlet 62B to the outlet 64B and provides a cooling function to the rotor 38A of the EESM 20A. A cooling loop 68B is further defined in the rotor 38B to access more surface area of the rotor 38A without touching any of the coils 70B.

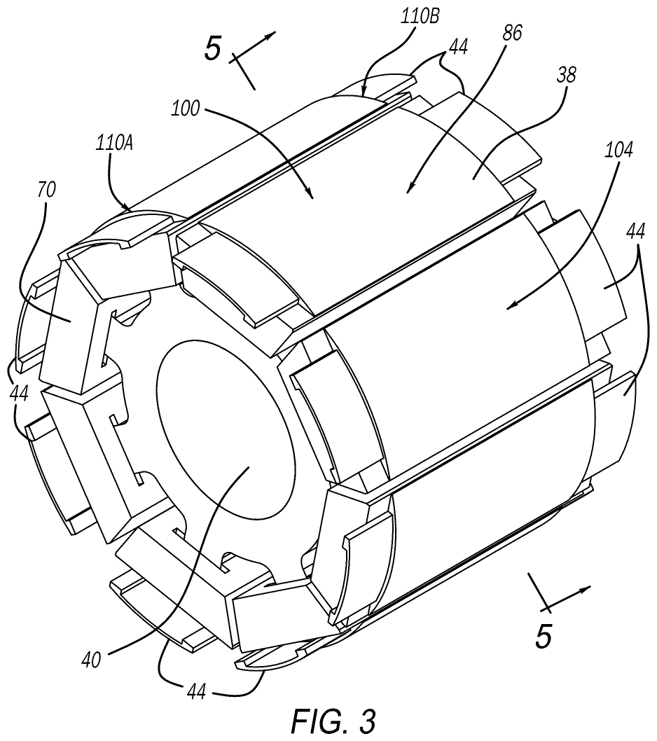

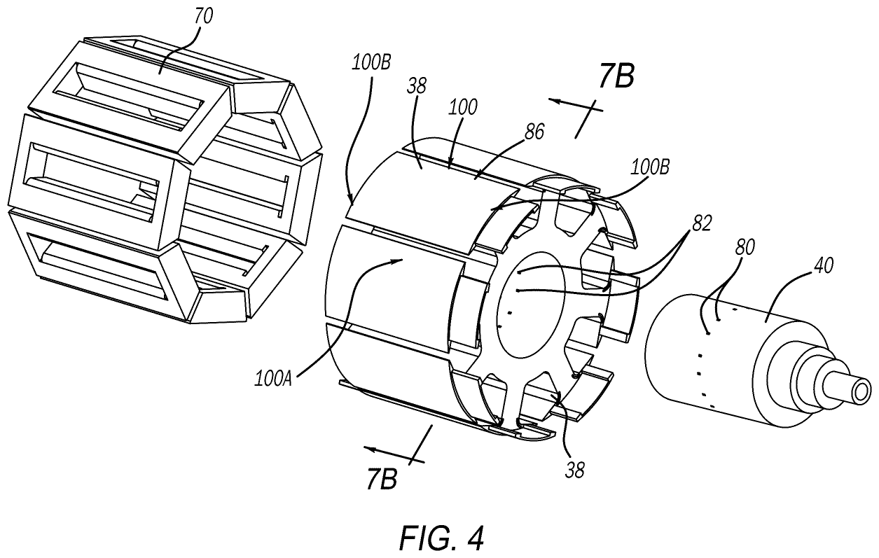

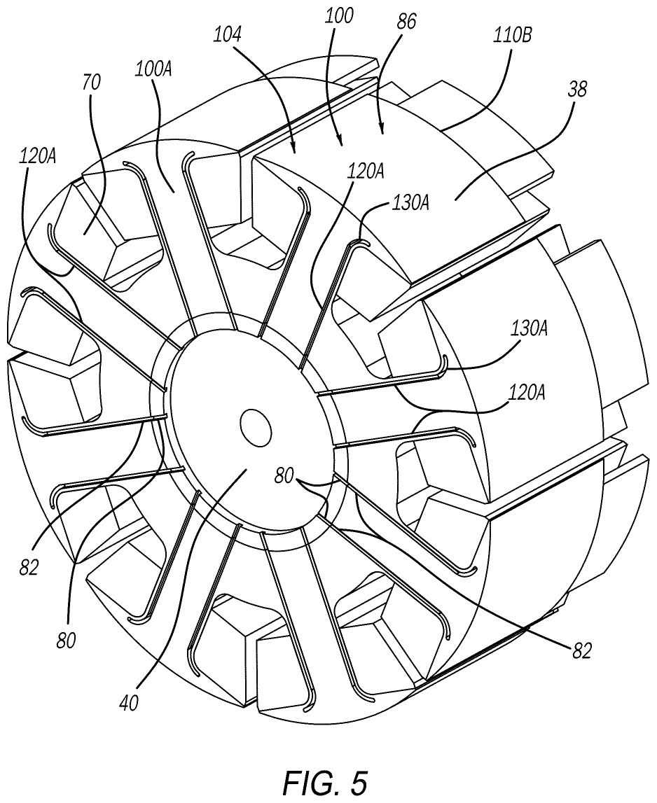

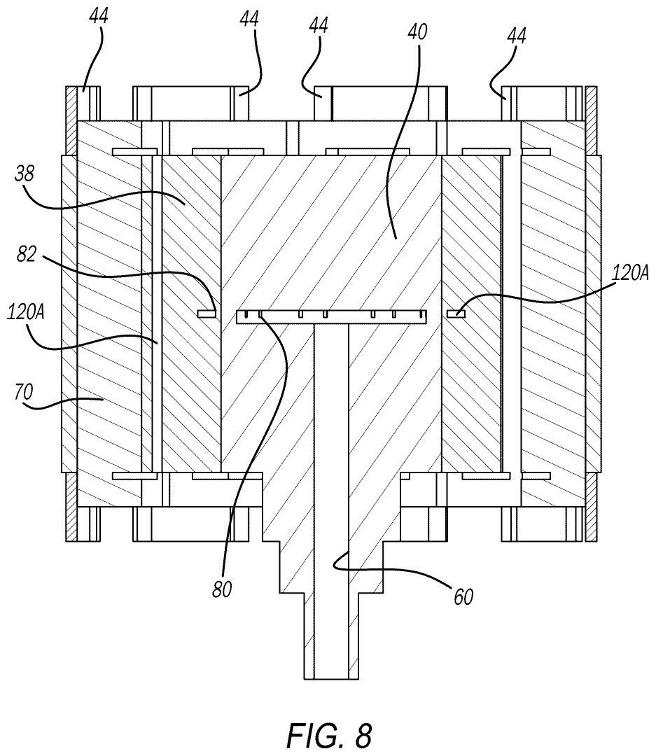

With further reference now to FIG. 2C-8, an ESSM 20 constructed in accordance to the present disclosure will be described. The EESM 20 generally includes a stator 36, a rotor 38, a rotor shaft 40 and a plurality of caps 44. In examples, the caps 44 can be attached to the rotor 38 and be formed of plastic. Further, the caps 44 guide the oil splashing to prevent airgap leakage. The rotor shaft 40 defines a passage 60 having an inlet 62 and a plurality of radially formed outlet passages 80 that feed complementary rotor inlet passages 82 defined in the rotor 38. The rotor 38 according to the present disclosure comprises a rotor laminations stack 86 and a coil assembly 70 (FIG. 3). The coil assembly, or coils 70 are known as magnet wires or copper wires are located on the rotor poles instead of permanent magnets. The caps 44 support the rotor coil assembly against centrifugal forces and guide oil splashing onto the coils 70.

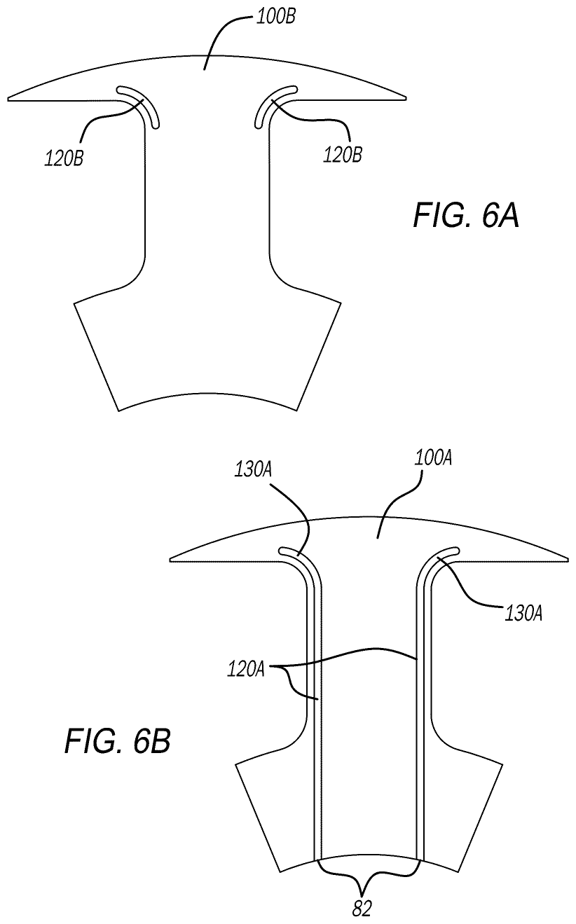

As will be described more fully herein, the rotor laminations stack 86 comprises a plurality of rotor laminations, collectively identified at reference 100. The plurality of rotor laminations 100 include a plurality of first laminations 100A (FIG. 6B) and a plurality of second laminations 100B (FIG. 6A). In the example shown, the plurality of first laminations 100A are generally arranged along a central portion 104 of the rotor 38. The plurality of second laminations 100B are generally arranged at opposite ends 110A, 110B of the rotor 38.

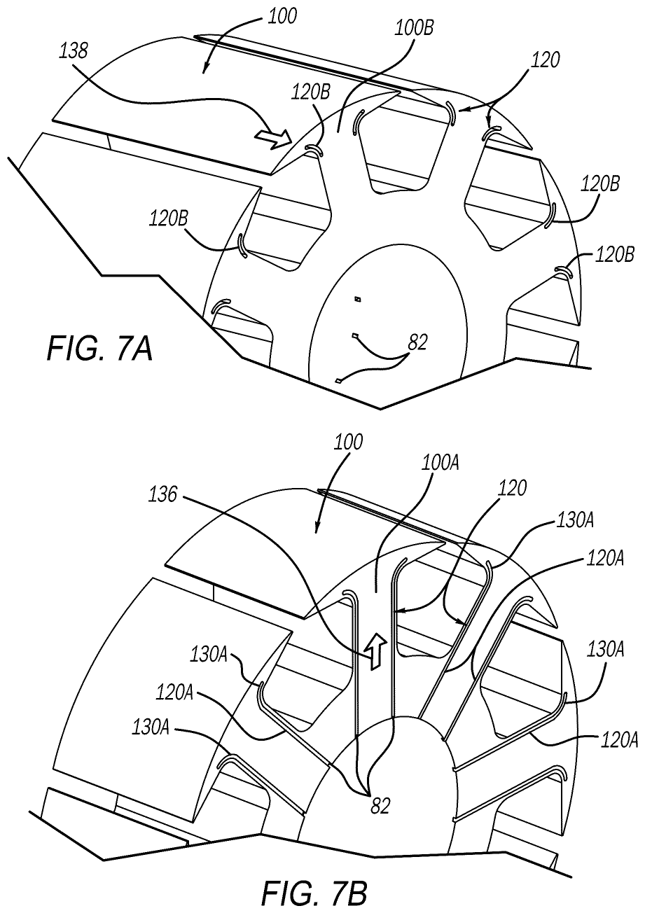

With particular reference now to FIGS. 7A and 7B, the plurality of rotor laminations 100 collectively define a plurality of channels, collectively referred to at reference 120. The channels 120 are defined by a plurality of first channels 120A defined in the first laminations 110A and a plurality of second channels 120B defined in the second laminations 110B. In examples, the plurality of first channels 120A are generally linear in geometry while the plurality of second channels 120B are generally arcuate in geometry.

As will be described herein, oil 66 is caused to flow initially into the rotor inlet passages 82 defined in the rotor 38 (from the outlet passages 80 of the shaft 40). Once in the rotor 38, the oil 66 flows in a generally radial direction 136 (FIG. 7B) along the plurality of first channels 120A. First arcuate distal end portions 130A are defined at ends of the plurality of first channels 120A. The first arcuate distal end portions 130A are formed with a similar geometry and align with the plurality of second channels 120B. The oil 66 flows generally from the first arcuate distal end portions 130A of the plurality of first channels 120A along the plurality of second channels 120B in a generally axial direction 138 (FIG. 7A).

In summary, the channels 120 have been created radially (e.g., channels 120A) to direct the oil 66 from the shaft 40 to the rotor body 38 and axially (e.g., channels 120B and 130A) to guide the oil 66 from the radial channels along the length of the rotor body to the rotor coils 70. The channels 120 are designed for consideration of electromagnetic, thermal, and mechanical factors.

The oil 66 directed from the channels 120 to the rotor coils 70 initially splashes onto the faces of the coils 70 on the rotor body side. Due to the centrifugal forces generated by the spinning rotor 38, the oil 66 then slides from the rotor coils 70 toward the outer part of the rotor 38. With additional reference back to FIG. 2C, the oil 66 is subsequently drained through one or more holes 210 in the housing 212 and returned to the oil cycle via a sump mechanism 220. The oil circulation helps maintain the electric motor 20 at a controlled temperature, ensuring optimal performance within the designated temperature ranges.

The configuration of the electric motor 12 not only provides more effective cooling but also simplifies the manufacturing process compared to more complex solutions. Additionally, it avoids the risk of oil 66 entering sensitive areas of the electric motor 12, such as the airgap, which could cause potential issues. The electric motor 12 offers a straightforward, direct, and efficient cooling solution that ensures full-length coil cooling in EESM's, addressing the limitations of previous methods and enhancing the overall electric motor performance. The specifically designed channels 120 of the present disclosure expel oil 66 to directly cool the rotor coils 70. Oil 66 is fed through these channels 120 and splashes onto the rotor coils 70, distributing the oil evenly due to the spinning motion of the rotor 38. This ensures comprehensive cooling along the entire length of the coils 70, rather than just at select points or regions.

It will be appreciated that the term “controller” or “module” as used herein refers to any suitable control device or set of multiple control devices that is/are configured to perform at least a portion of the techniques of the present disclosure. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present disclosure. The one or more processors could be either a single processor or two or more processors operating in a parallel or distributed architecture.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

What is claimed is:

1. An electric motor for powering an electric vehicle, the electric motor comprising:
a rotor configured to rotate relative to a stator to drive a rotor shaft and at least one drive wheel of the electric vehicle, wherein the rotor shaft defines a passage having an inlet and a plurality of radially formed outlet passages;
coils positioned at respective poles of the rotor; and
wherein the rotor comprises:
a plurality of first laminations arranged along a central portion of the rotor, the plurality of first laminations defining a plurality of first channels that extend in a radial direction and are configured to receive cooling fluid from the outlet passages; and
a plurality of second laminations arranged at opposite ends of the rotor, the plurality of second laminations defining a plurality of second channels that extend in an axial direction and are configured to receive the cooling fluid from the plurality of first channels and expel the cooling fluid onto the coils.

2. The electric motor of claim 1, wherein the rotor defines a plurality of rotor inlet passages that receive the cooling fluid from the rotor shaft.

3. The electric motor of claim 2, wherein the plurality of rotor inlet passages align with the plurality of outlet passages on the rotor shaft.

4. The electric motor of claim 1, wherein the plurality of first channels have a linear geometry.

5. The electric motor of claim 4, wherein the plurality of second channels have an arcuate geometry.

6. The electric motor of claim 5, wherein first arcuate distal end portions are defined at ends of the plurality of first channels.

7. The electric motor of claim 6, wherein the first arcuate distal end portions align with the plurality of second channels.

8. The electric motor of claim 1, further comprising:
a housing that houses the rotor, wherein the housing defines at least one hole that the cooling fluid drains out of after engaging the coils and returns to the rotor shaft by way of a sump mechanism.

9. The electric motor of claim 1, wherein the cooling fluid comprises oil.

10. The electric motor of claim 1, wherein the coils are directly sprayed from the rotor.

11. The electric motor of claim 10, wherein the coils are directly sprayed from the plurality of second channels.

12. The electric motor of claim 8, wherein the stator is fixed to the housing.

13. The electric motor of claim 1, further comprising:
a plurality of caps attached to the rotor and that guide oil splashing onto the coils.

14. The electric motor of claim 13, wherein the plurality of caps are attached to the rotor.

15. The electric motor of claim 14, wherein the plurality of caps are formed of plastic.

16. A method of cooling coils of an electric motor that powers an electric vehicle, the method comprising:
providing a rotor configured to rotate relative to a stator to drive a rotor shaft and at least one drive wheel of the electric vehicle, wherein the rotor shaft defines a passage having an inlet and a plurality of radially formed outlet passages, the rotor having a plurality of first laminations arranged along a central portion of the rotor, the plurality of first laminations defining a plurality of first channels that extend in a radial direction and are configured to receive cooling fluid from the outlet passages; and a plurality of second laminations arranged at opposite ends of the rotor, the plurality of second laminations defining a plurality of second channels that extend in an axial direction and are configured to receive the cooling fluid from the plurality of first channels and expel the cooling fluid onto the coils;
delivering the cooling fluid through the passage in the rotor shaft;
directing the cooling fluid from the outlet passages in the rotor shaft into the plurality of first channels;
directing the cooling fluid from the plurality of first channels to the plurality of second channels; and
expelling the cooling fluid from the plurality of second channels and onto the coils, whereby the coils are cooled from the cooling fluid.

17. The method of claim 16, further comprising:
subsequent to expelling the cooling fluid, draining the oil through at least one hole in a housing that houses the rotor and into a sump.

18. The method of claim 17, further comprising:
pumping the oil from the sump back to the rotor shaft.

19. The method of claim 16, wherein delivering the cooling fluid comprises delivering oil.
